(19) United States
(12) Patent Application Publication
(10) Pub. No.: US 2025/0282998 A1
(43) Pub. Date: Sep. 11, 2025

(54) METHODS AND APPARATUS FOR SUPERTORREFACTION OF BIOMASS

(71) Applicant: Astron Solutions Corporation, Atherton, CA (US)

(72) Inventors: Frank Hsia-San Shu, Atherton, CA (US); Ronald Everett Taam, Winnetka, IL (US); Paul Tsang Pop Ho, Carlisle, MA (US); Shan Heng Chien, Tustin, CA (US)

(73) Assignee: Astron Solutions Corporation, Atherton, CA (US)

(21) Appl. No.: 18/601,895

(22) Filed: Mar. 11, 2024

(51) Int. Cl. C10B 49/14; C10B 53/02; C10B 57/00; C10B 57/14

(52) U.S. Cl. CPC C10B 49/14; C10B 53/02; C10B 57/005; C10B 57/14

(57) ABSTRACT

Under current practices, agricultural or landscaping waste left in a field or forestry waste left in a forest will decay and release greenhouse gases. In addition, forestry waste also poses a high risk for fires. Accordingly, mechanisms are provided to allow efficient conversion under anaerobic conditions of biomass, such as agricultural or forestry waste, into biocarbon product, such as biochar, biocoal, inert carbon and/or activated carbon, using molten salts as a more efficient heat transfer medium than conventional heat. Specifically, biomass is converted into biocarbon product during a supertorrefaction process during which molten salts are pumped under anaerobic conditions from a molten salt reservoir to a batch process cooker that holds the biomass. The salts are washed from the resulting biocarbon product as needed.

### RELATED ART

During supertorrefaction, several physical and chemical changes occur in the biomass including the removal of moisture, volatiles, and hemicellulose, resulting in a material with higher energy density and increased carbon content. Depending on the operating condition, the output of supertorrefaction can be a range of biocarbon products from those with a highly energy-dense solid biofuel, often referred to as biocoal, to a less energy containing product for agriculture such as biochar or an inert carbon product suitable for carbon sequestration. This material has improved handling and storage properties compared to raw biomass and can be used in multiple applications like power generation and industrial heating, agriculture or carbon sequestration. Thus, the process is tunable by selecting operating conditions to produce a range of products.

Under some operating conditions, the supertorrefaction process can help reduce carbon emissions when biofuel produced by the process is used in place of fossil fuels. It is considered a carbon-neutral or even carbon-negative technology because the carbon dioxide (CO₂) released during combustion of the biofuel is offset by the carbon captured from the biomass through production of the biofuel. Under other operating conditions, the supertorrefaction process can produce carbon rich products suitable for application in agriculture or carbon sequestration either above or below ground.

Supertorrefaction has gained attention as a sustainable approach to biomass utilization and a means of producing a renewable and cleaner-burning solid fuel. It offers advantages in terms of energy density, transportability, and reduced greenhouse gas emissions when compared to untreated biomass. This application describes further improvements to the methods and apparatus that enable the use of the technology to produce products efficiently on a large scale by reducing the amount of energy and resources required to treat and convert the biomass into biocarbon product such as biocoal as biofuels or as biochar for agricultural use or for inert carbon for sequestration above or below ground.

### Overview

Under current practices, agricultural or landscaping waste left in a field or forestry waste left in a forest will decay and release greenhouse gases. In addition, forestry waste also poses a high risk for fires. Because greenhouse emissions and fire risks negatively impact the environment, including contributing to negative impacts from climate change, effectively treating and processing biomass such as agricultural and forestry waste can significantly reduce these negative impacts. Accordingly, mechanisms are provided to allow efficient conversion of biomass, such as agricultural or forestry waste, into biocarbon products, such as biochar, biocoal, inert carbon, and/or activated carbon under anaerobic conditions using molten salts as a heat transfer medium. Specifically, biomass is converted into biocarbon products through a supertorrefaction process wherein molten salt is pumped from a molten salt reservoir to a batch process cooker that holds the biomass. In particular, molten salt is distributed through a plenum lid located on top of the cooker to flow vertically through the biomass before being collected in a molten salt reservoir located below the cooker.

The operating conditions of the batch process cooker and plenum lid can be varied to produce biocarbon products with the desired chemical and physical properties suitable for specific applications. The composition of the molten salts can also be varied to produce the biocarbon product suitable for specific applications. During treatment of the biomass with the molten salt, the biomass is converted into biocarbon products such as biochar, biocoal, activated carbon, or the like. The processed biocarbon products are then washed in a sluice washer to remove excess salt deposited during the supertorrefaction process. The process can be enclosed, process intermediates are captured, energy and water are conserved. There is minimal emission. The enclosed system enables conservation of resources and management of processor steps by automation which respond to and sensors for process parameters to feedback information for the automation. Under some settings, the process can also be left open and the flexibility in the apparatus settings allows alternative settings to be chosen.

The resulting biocarbon products, such as washed biochar, biocoal, inert carbon, and/or activated carbon, can be used as a more carbon neutral, cleaner-burning source of energy or stored in a carbon capture environment that provides a carbon negative result. In some examples, the biocarbon products can be sequestered and stored in the ground or other location so that these products do not produce greenhouse gases or other negative environmental effects. In other examples, the biocarbon products can be used as a cleaner burning fuel with an overall carbon neutral or carbon negative impact on the environment. In the following disclosure, various illustrative, non-exclusive examples of inventive features relating to improved mechanisms and processes are described with reference to the figures below.

### BRIEF DESCRIPTION OF THE DRAWINGS

The disclosure may best be understood by reference to the following description taken in conjunction with the accompanying drawings, which illustrate particular example embodiments.

FIG. 1 is a diagrammatic representation of an example of a supertorrefaction system.

FIG. 2 is a diagrammatic representation of an example of a cylindrical cooking system.

FIG. 3 is a diagrammatic representation of an example of a plenum lid.

FIG. 4 is a diagrammatic representation of an example of a biomass basket.

FIG. 5 is a diagrammatic representation of an example of a sluice washer.

FIG. 6 is a flow process diagram of an example of a supertorrefaction process.

FIG. 7 is a diagrammatic representation of an example of a control system used to automate the supertorrefaction process.

### DETAILED DESCRIPTION

In the following description, specific details are set forth to provide illustrative examples of the systems and techniques described herein. The presented concepts may be practiced without some, or all, of these specific details. In other instances, well known process operations have not been described in detail to avoid unnecessarily obscuring the described concepts. While some concepts will be described with the specific examples, it will be understood that these examples are not intended to be limiting.

Supertorrefaction is a thermal treatment process that involves heating biomass materials, such as wood, agricultural residues, or other organic matter, in a low-oxygen environment submerged in molten salts to transform raw biomass into a range of biocarbon products, including those with more energy-density to those that are carbon intense stable inert carbon products. One key benefit of this process is that biomass is heated in an environment with limited oxygen to prevent combustion and reduce the release of greenhouse gases. Supertorrefaction involves heating biomass at temperatures significantly higher than those used in traditional torrefaction. Compared to torrefaction, supertorrefaction involves a shorter residence time of a few minutes within a reactor, instead of conventional torrefaction which requires times from at least 30 minutes but generally to more than a few hours.

Conventional torrefaction products that are minimally treated at 30 minutes have significant levels of remaining greenhouse generating potential to render them basically untreated biomass. The shorter processing time by supertorrefaction allows for faster and greater devolatilization and thermal decomposition of the biomass to remove the potential for formation of greenhouse gases. Supertorrefaction has operating parameters that can be defined, controlled and monitored for performance. The range in operating conditions in supertorrefaction also means the process is tunable, where the preselected conditions such as salt composition, temperature, contact time, and other biomass treatment variables can be selected to shape the composition of the final product. The current application extends the range of operating conditions to add to those described in earlier filings. The result is also the ability to produce more carbon intense product than was possible with the earlier operating conditions. Various embodiments of the present invention also relate to monitoring, controlling, and automating supertorrefaction processes.

According to various embodiments, a supertorrefaction system includes a cooker having a plenum lid that distributes the molten salts onto the biomass in the cooker in a manner that converts the biomass into biocarbon product, such as biochar, biocoal, inert carbon and activated carbon. Any individual or mixture of a variety of carbon rich materials derived from biomass, agricultural waste, or organic waste used for carbon sequestration or as a substitute for fossil-derived carbon-based materials is referred to herein as biocarbon product. Some examples of biocarbon product include biochar, biocoal, inert carbon, activated carbon, biomass pellets, and bio-based chemicals.

The resulting biochar or other biocarbon products can then be washed to various degrees using a cleaning sluice and either sequestered, used as soil amendments or reused as a renewable biofuel in its more energy intense and clean burning form. The composition of the salts can be any eutectic salt mixture and the operating conditions of the batch process cooker and plenum lid can be varied in a tunable process to different temperatures, contact times and salt combinations to produce biocarbon products with the desired chemical and physical properties suitable for specific applications. The process intermediates are captured and condensed, energy and water can be recycled within the process. The process can be fitted with sensors and automated through the use of computer controls.

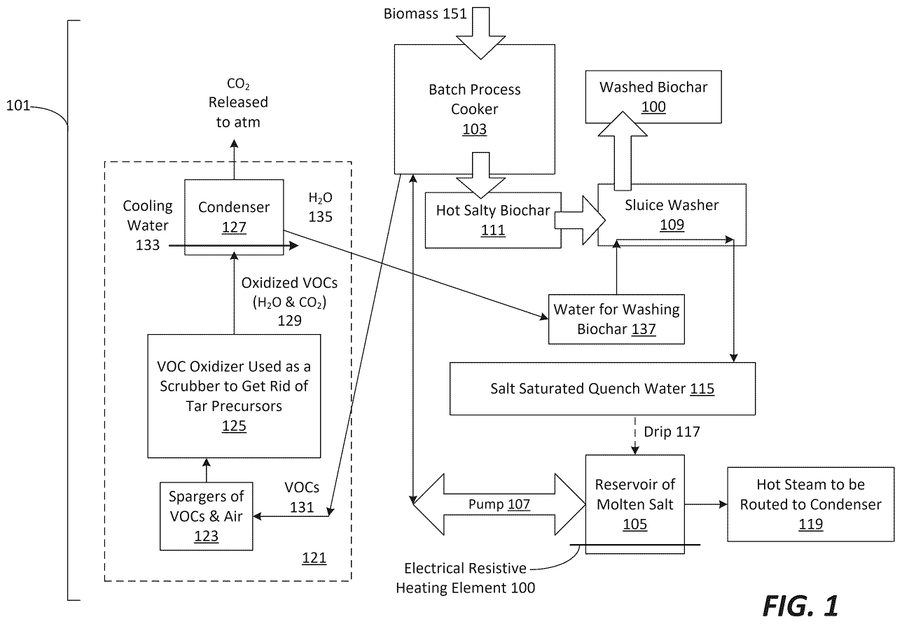

With reference to FIG. 1, shown is a diagrammatic representation of an example of a supertorrefaction system 101. The supertorrefaction system 101 efficiently converts biomass into biocarbon products while addressing environmental concerns and optimizing resource utilization. Supertorrefaction system 101 includes a batch process cooker 103, such as a cylindrical cooker, a molten salt reservoir 105, a molten salt pumping system 107, a sluice washer 109 or other washer for salty biocarbon product, and a VOC (Volatile Organic Compounds) management system 121.

According to various embodiments, a batch process cooker 103 is a core component of the system, where biomass 151 is thermally treated at high temperatures and low oxygen levels to produce biocarbon products. In the present example, biomass 151 undergoes a supertorrefaction process in batch process cooker 103 until it is converted into hot salty biocarbon product 111. Specifically, once the biomass 151 is placed in batch process cooker 103, hot molten salt is distributed onto biomass 151 within batch process cooker 103, such that the molten salt flows through biomass 151 and provides the heat necessary to convert the biomass into biocarbon product 111. In the present example, hot molten salt is pumped from a reservoir 105 into batch process cooker 103 using pump 107. The molten salt is heated in reservoir 105, which includes an electrical resistive heating element 110 that keeps the molten salt at a desired temperature necessary for the supertorrefaction process. Once the molten salt flows through and out of the batch process cooker 103, it is recirculated into the reservoir of molten salt 105 to be reheated and recirculated again into the batch process cooker 103.

In particular embodiments, the hot salty biocarbon product 111, which has been produced by the supertorrefaction process in the batch process cooker 103, is removed using a robotic arm that either moves a basket holding the salty biocarbon product 111 from the batch process cooker 103 to a sluice washer 109 or moves the biocarbon product 111 from the batch process cooker into a basket in the sluice washer 109, such as by tipping the batch process cooker or a vessel within the batch process cooker so that the biocarbon product 111 falls into the basket in the sluice washer.

In the present example, the sluice washer 109 is used to wash the hot salty biocarbon product 111 and remove salts and other contaminants from the biocarbon product 111. As shown, water 137 passes into sluice washer 109 and flows out of the sluice washer 109 as quench water 115, which is saturated with salt from washing the hot salty biocarbon product 111. The quench water 115 can be directed back into the reservoir of molten salt 105 to replenish salt levels and maintain the system's functionality. In the present embodiment, the salt saturated quench water can be dripped 117 into the reservoir of molten salt 105. This drip 117 can be used to direct the desired salt into reservoir 105 without including excess water or contaminants. In addition, hot steam 119 generated in the system 101 can be routed back to a condenser 127 or used for other heating applications within the system. The washed biocarbon product 100 can be collected for use outside of system 101. For instance, the washed biocarbon product 100 can be sold as carbon offsets to companies or other entities that produce excess greenhouse gas emissions in order to reduce the net greenhouse gases emitted.

In particular embodiments, VOCs are generated as byproducts of the supertorrefaction process in the cylindrical cooker 103. To remove the volatile organic compounds (VOCs) 131 generated during the supertorrefaction process, an exhaust pipe connects the cooker 103 to a VOC management unit 121 that collects and processes the VOCs 131. This VOC management system may include one or more spargers 123, VOC oxidizers 125, and condensers 127.

In the present example, the VOCs 131 are extracted from cooker 103 and routed for further processing. According to various embodiments, spargers 123 or exhaust systems are used to capture the VOCs 131 and control the airflow within the supertorrefaction chamber. Specifically, the spargers 123 direct VOC-laden gases to the next stages of treatment.

In particular embodiments, the VOC oxidizer 125, often in the form of a scrubber, is responsible for converting the VOCs 131 into less harmful compounds by oxidizing them. This helps prevent the formation of tar precursors and reduces emissions. According to various embodiments, after passing through the oxidizer, the VOCs 131 are converted into water vapor (H₂O) and carbon dioxide (CO₂) 129, which are less harmful and easier to manage.

In the present example, a condenser 127 cools down and condenses the hot gases, using cooling water 133. The condensed products include condensed water 135, now in liquid form, and CO₂ that is released into the atmosphere. The condensed water 135 can be recirculated within the system depending on the desired implementation. For instance, the condensed water 135 can be used for one or more purposes, such as washing the salty biocarbon product, cooling the equipment, or other thermal management tasks. As shown in the present example, the condensed water 135 can be directed to be used as water for washing biocarbon product 137.

As described, the integrated supertorrefaction system 101 not only efficiently converts biomass 151 into biocarbon product 100 but also manages VOC emissions, addresses environmental concerns, and maximizes resource utilization by recycling and repurposing water and heat energy. It demonstrates a comprehensive approach to sustainable biomass processing while minimizing environmental impact. In particular, the net effect of processing biomass 151 into biocarbon product 100 with system 101 is to significantly reduce the amount of greenhouse gases that would have been produced if the biomass 151 were instead allowed to decay on its own.

By varying the operating temperature, the composition of the salts, the duration of supertorrefaction, and the variety of the incoming biomass, a range of biocarbon products may be produced, rendering the process tunable to the desired application. It should be noted that a variety of salts and salt combinations may be used in system 101. For instance, any combination of eutectic salts is within the scope of the invention.

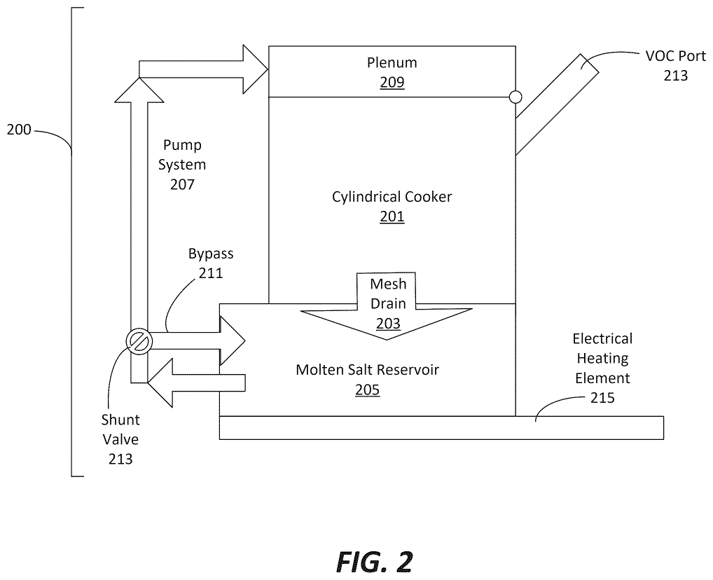

With reference to FIG. 2, shown is a diagrammatic representation of one example of a cylindrical cooking system 200 that can be used in a supertorrefaction process. In the present embodiment, cylindrical cooker 201 can be used as a batch process cooker to transform biomass into biocarbon product via a supertorrefying batch process. In some examples, cylindrical cooker 201 can include a porous basket and may be situated as a cylindrical stationary cooker. According to various embodiments, the cylindrical cooker 201 itself is a robust, cylindrical vessel made of heat-resistant materials, such as stainless steel or specialized alloys. It is designed to withstand high temperatures and corrosive environments.

According to various embodiments, the cooking system 200 includes a hoist system that facilitates inserting a portable porous basket filled with a batch of biomass into cylindrical cooker 201. The holding basket remains within the cylindrical cooker 201 during the supertorrefaction process. In some implementations, the hoist system can also be used to remove the holding basket from the cylindrical cooker after the biomass has been converted to biocarbon products.

In particular embodiments, the bottom of the cylindrical cooker 201 features a mesh drain 203, perforated plate, or the like, which is designed to allow molten salt to pass through the cylindrical cooker 201 while allowing the biomass and/or biocarbon product to remain within the cylindrical cooker 201 throughout the supertorrefaction process. According to various embodiments, the mesh drain 203 is used to facilitate the controlled flow of molten salt out of the cylindrical cooker 201 and into a molten salt reservoir tank 205 that is located below the cylindrical cooker 201. Salts are collected, heated, and maintained at a specified temperature in a molten state in the molten salt reservoir tank 205. The molten salt reservoir tank 205 may be constructed to handle the high temperatures and corrosive nature of molten salt. According to various embodiments, the molten salt reservoir tank 205 includes one or more electrical resistive heating elements 215 used to melt the salt to a fluid state and to maintain it at a constant predetermined temperature, for example 200-700 degrees Celsius. In particular embodiments, this molten salt is pumped vertically through a supply pipe connecting a molten salt reservoir 205 to the cylindrical cooker 201 or other cooking structure through a plenum lid 209 that is located above the cylindrical cooker 201. The molten salt flows from the plenum lid onto the biomass within the cylindrical cooker 201. In particular, molten salt is evenly distributed on top of the biomass, such that it flows through the basket of biomass and transfers its heat to the biomass in a manner that converts it into biocarbon product through supertorrefaction. A filtration mesh apparatus, such as mesh drain 203, located at the bottom of the supertorrefaction unit keeps the biomass and resultant biocarbon product within cylindrical cooker 201 while allowing the molten salt liquid to pass through and drain into the underlying molten salt reservoir 205 to be re-heated and recycled through the supertorrefaction system.

According to various embodiments, a pump system 207 is connected to the molten salt reservoir and is responsible for circulating the molten salt into the cylindrical cooker 201. In the present example, the pump system 207 includes a pump and pipes connecting the molten salt reservoir 205 to the plenum lid 209 above cooker 201. The pump drives the molten salt heat transfer liquid through a pipe that connects the reservoir 205 to plenum lid 209 of the cooker. In particular embodiments, the plenum lid 209 is designed with an array of holes at its base through which the molten salt heat transfer liquid flows, such that the molten salt is uniformly distributed over the biomass located in cooker 201. The plenum lid 209 may include features such as distribution channels, nozzles, a network of pipes, or the like, that help to evenly distribute the molten salt on top of the biomass within the cylindrical cooker 201. In the present example, molten salt flows vertically from the plenum lid 209 through a basket within cooker 201 to directly contact the biomass within the basket. As the hot molten salt passes through the biomass and out of the cylindrical cooker 201 through drain 203, heat is transferred to the biomass at a temperature that allows the biomass to be converted into biocarbon product through a supertorrefaction process.

In particular embodiments, pump system 207 includes a bypass system 211. This system 211 allows the pumped molten salt to be redirected back into the reservoir 205 when the cylindrical cooker 201 is open, such as when biomass is loaded or when biocarbon product is being removed from cylindrical cooker 201. For instance, during periods when a basket of loaded biomass is inserted into the cylindrical cooker 201 and/or a basket of biocarbon product is removed from the cooker 201 for washing and cooling, the flow of hot molten salt into the cooker 201 needs to be paused. In particular, the molten salt flow to the cooker is bypassed and redirected by a shunt valve 213 from the reservoir tank 205 through bypass 211 and back into the reservoir tank 205. In the present example, the shunt valve 213 diverts the molten salt liquid flow to bypass the cooker and routes the liquid directly back into the reservoir 205 during two time periods. Specifically, recirculation of fluid within the bypass system 211 takes place when (i) biomass is loaded into the receiving cooker, such as when biomass is loaded into a basket within the cooker or when a basket holding biomass is loaded into the cooker, and (ii) when a basket of salty biocarbon product is removed from the cooker and unloaded into a porous washing basket for cleaning and cooling. In the present example, recirculation of the molten salt within the bypass system 211 helps the molten salt to maintain a consistent temperature and prevents unnecessary heat loss during loading and unloading of biomass and biocarbon product batches.

According to various embodiments, the cooking system 200 can also include a VOC port 213 that allows VOCs produced during the supertorrefaction process to flow out of the system 200 for further treatment. For instance, the VOC port 213 may be routed to a VOC management system 121, as described above with regard to FIG. 1. There, the VOCs are processed into less harmful substances before being released into the atmosphere. Alternatively, the VOCs may also contain substances of value that can be captured and used in other applications.

In the present example, the supertorrefaction process involves pumping molten salt from reservoir 205 to plenum lid 209 that evenly distributes the molten salt onto the top of the biomass located inside a container within the cylindrical cooker 201. In some examples, the container may be a cylindrical basket, such as a mesh basket, a cylindrical vessel with a mesh bottom, etc. The molten salt flows through the biomass, effectively heating and converting it into biocarbon product. The entire process is controlled and monitored by a computer-based control system. This system regulates the temperature, flow rate, and timing of the circulation of molten salt, ensuring optimal supertorrefaction conditions. The system also controls the recirculation of molten salt in the bypass system, which increases the overall energy efficiency and safety of the biomass supertorrefaction process. The system can also be used to create an integrated system linked to the washing system.

Although the present example describes using a cylindrical cooker 201, it should be noted that other shapes of cookers may be used depending on the desired implementation. Accordingly, an elliptical, rectangular, square, barrel-shaped, spherical, or other shaped cooker may be used in some applications without departing from the scope of the present disclosure. Furthermore, although the present example describes a stationary cooker, moveable cookers, such as moveable spherical cookers, may be used in some implementations.

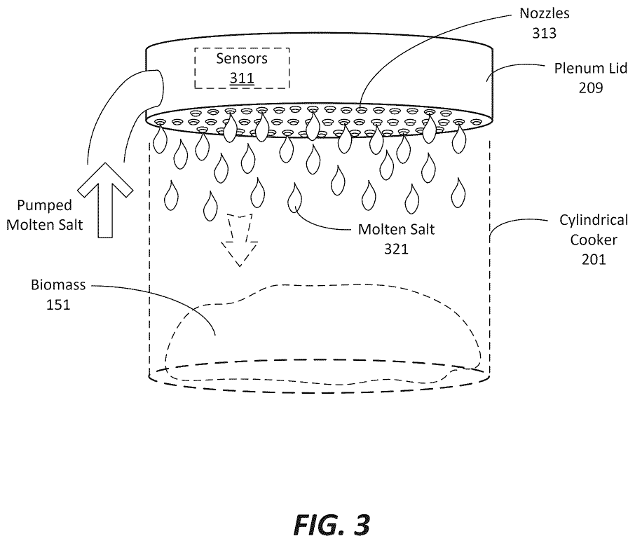

With reference to FIG. 3, shown is a diagrammatic representation of an example of a plenum lid. As described above with regard to FIGS. 1 and 2, a plenum lid 209 can be used as a vessel to distribute molten salt onto biomass as part of a supertorrefaction process to convert the biomass into biocarbon products such as biochar, biocoal, inert carbon, and/or activated carbon. According to various embodiments, the plenum lid 209 is designed as a flat, circular, rectangular, or other-shaped structure that covers the top opening of a cylindrical cooker 201. The lid 209 is typically made of heat-resistant materials, such as stainless steel, capable of withstanding high temperatures and exposure to molten salt. According to various embodiments, a wide range in temperatures, such as 200° C. to 700° C. can be used. In some embodiments, the plenum lid 209 includes an intricate network of distribution channels, pipes, nozzles, or the like, that allows the molten salt to be evenly spread and/or sprayed over the surface of a batch of biomass 151 located within the cylindrical cooker 201.

According to various embodiments, the distribution channels or nozzles 313 allow the molten salt 321 to be distributed uniformly across the entire top surface of the biomass 151. This even distribution is important for achieving consistent heating and conversion of the biomass into biocarbon product. In particular embodiments, some plenum lids may have adjustable mechanisms or flow control valves that allow operators to fine-tune the distribution of molten salt based on specific process requirements.

In the present example, the plenum lid 209 is connected to a molten salt supply system. Molten salt is pumped into the lid 209 from a reservoir of molten salt and is directed into the distribution channels or nozzles 313. In particular embodiments, the plenum lid 209 relies on gravity to facilitate the flow of molten salt from the distribution channels onto the biomass below.

According to various embodiments, the plenum lid 209 helps maintain a consistent temperature within the cylindrical cooker, as the molten salt not only heats the biomass but also transfers heat to structures within the cylindrical cooker throughout the process. Maintaining a consistent temperature within the cooker can improve the quality and efficiency of the supertorrefaction process. For instance, by maintaining a consistent temperature within the cylindrical cooker, the biomass can be uniformly processed at the same temperature throughout the batch.

In the present embodiment, the plenum lid 209 is integrated into the overall control system of the supertorrefaction equipment. It receives commands and instructions regarding the timing, flow rate, and duration of molten salt distribution. Temperature and pressure sensors 311 may be installed in the lid to provide real-time data to the control system, allowing for precise monitoring and adjustment of the supertorrefaction process. Safety interlocks may be incorporated into the lid's design to ensure that the distribution of molten salt can be immediately stopped in case of emergencies or system malfunctions. In some implementations, the plenum lid 209 may also include heat insulation or heat-resistant coatings to protect operators and maintain the integrity of the lid structure.

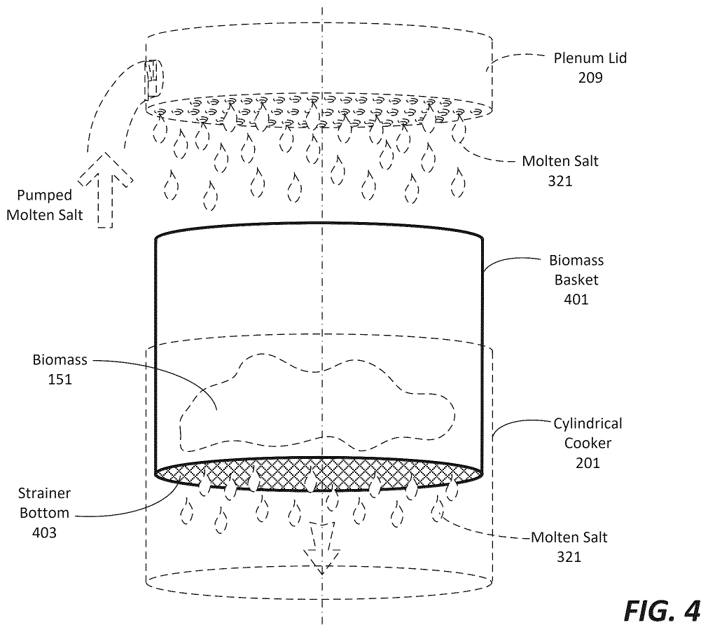

With reference to FIG. 4, one example of a biomass basket is shown as part of a blow-apart diagram. In this example, biomass basket 401 is shown relative to a cylindrical cooker 201 and a plenum lid 209. As described above with regard to FIGS. 1-3, the cylindrical cooker 201 and plenum lid 209 can be used together to hold and process a batch of biomass 151 into biocarbon product during a supertorrefaction process.

According to various embodiments, the biomass basket 401 is constructed from heat-resistant materials such as stainless steel capable of withstanding the extreme temperatures. The biomass basket 401 is built to withstand the extreme temperatures of a molten salt supertorrefaction process without warping, corroding, or deteriorating. In particular embodiments, the biomass basket 401 is cylindrical with solid sides and a strainer bottom 403 designed to allow molten salt 321 to flow from a plenum lid 209 through the biomass 151 and out of the biomass basket 401 through a strainer bottom 403.

In the present example, the basket 401 is cylindrical in shape, resembling a tall, open-ended cylinder with a flat base. The size of the biomass basket 401 can be selected based on the specific application and the volume of biomass to be processed in conjunction with the molten salt. In particular embodiments, the sides of the basket are solid and made of a sturdy, perforation-free metal material. These solid sides are designed to contain the biomass material 151 and molten salt 321 during the supertorrefaction process.

According to various embodiments, the bottom of the basket 401 includes a strainer design 403 that allows molten salt 321 to flow through the bottom of the basket 401 into a molten salt reservoir. In particular embodiments, this strainer 403 includes evenly spaced holes, slots, mesh, porous material, or the like, specifically designed to facilitate the flow of molten salt through the basket 401 while retaining the biomass and/or processed biocarbon product inside the basket 401 throughout the supertorrefaction process.

In the present example, the top of basket 401 is connected to a plenum 209 having multiple openings or inlets through which molten salt is introduced into the basket 401. In particular embodiments, the inlets can be fitted with a mechanism for precise control of the molten salt flow rate. In other examples, the biomass basket may be nested within a stationary cylindrical cooker 201 and the plenum lid 209 may be positioned above, but not necessarily in contact with, the biomass basket. In yet other examples, the biomass basket and the cylindrical cooker may be combined into one structure such that the biomass basket serves as the cylindrical cooker 201. In each of these examples, the cylindrical cooker may be stationary or moveable, depending on the desired implementation.

According to various embodiments, an attachment at the top of the biomass basket 401 is included to allow a robotic arm to remove the basket 401 from the cylindrical cooker 201 before and/or after processing a biomass 151 batch. Using a robotic arm to engage the biomass basket 401 allows for automation and safe handling of the basket 401 during loading of the raw biomass and removal of the processed biocarbon product or other solid materials. In particular embodiments, the top of the basket includes an interface designed to be compatible with the end effector or gripper of a robotic arm. This interface may include features such as mechanical connectors, fasteners, or a specific pattern for robotic arm attachment. The attachment is engineered to allow the robotic arm to securely attach to or grip and lift the basket with minimal risk of slippage or accidents. This often involves the inclusion of handles, hooks, or other suitable lifting mechanisms. The attachment may incorporate additional safety features like sensors or locking mechanisms to ensure that the basket is properly secured before being lifted. In particular embodiments, the attachment is reinforced to handle the weight of the loaded biomass basket 401, which can be substantial, especially in industrial-scale processes.

In some embodiments, the attachment may have a control interface that allows the robotic arm to communicate with the attachment, ensuring proper engagement and disengagement. The attachment is designed to be compatible with the specific supertorrefaction chamber and robotic arm system in use, ensuring seamless integration and operation and facilitating the automation of the supertorrefaction process, improving efficiency, reducing the risk of accidents, and allowing for precise control over the timing and handling of the basket. According to various embodiments, remote operation can be implemented, which is particularly valuable in situations where the supertorrefaction chamber is located in a hazardous environment or where human access is limited or unsafe.

According to various embodiments, a transporting apparatus such as hoist system can be used to lift a basket 401 of processed biocarbon product from the supertorrefaction cooker 201 and/or tip the basket 401 to allow the biocarbon product to fall into a cylindrical washing chamber, where excess salt and other contaminants can be washed from the processed biocarbon product. It should be noted that in some embodiments, the basket 401 of biocarbon product is itself used as a washing chamber or is lifted and placed into a washing chamber or other washing location.

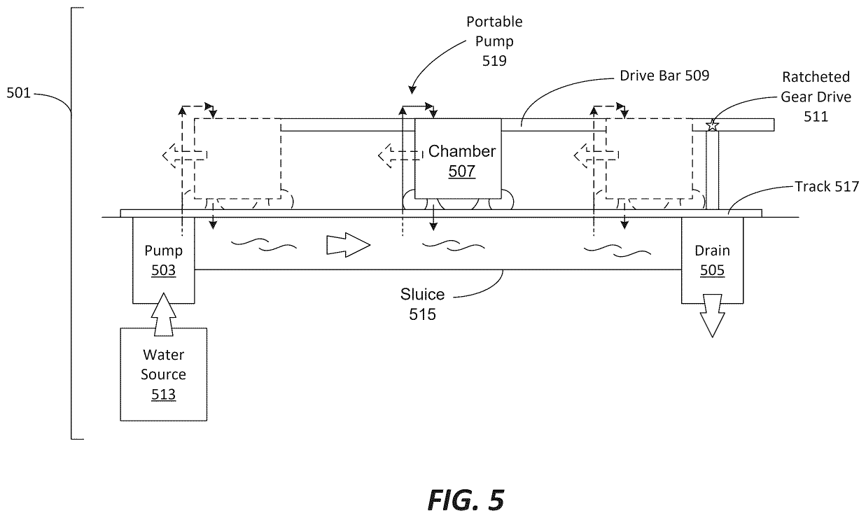

In particular embodiments, processed biocarbon product is washed of its salt content using a sluice washer, an example of which is shown and described with regard to FIG. 5. With reference to FIG. 5, a diagrammatic representation of one example of a sluice washer 501 is shown, which can be used to wash salty biocarbon product produced in a supertorrefaction process as described above with regard to various examples. In the present example, sluice washer 501 includes a cylindrical chamber 507 that rolls on a track 517 that can include rails or other guide mechanisms or structures, in an intermittent manner above and along the length of an open-ended sluice 515. According to various embodiments, the sluice 515 is a channel through which water can flow. A pump 503 fixed at one end of the sluice 515 inputs fresh water, which flows horizontally through the sluice 515 and out through drain 505. A portable pump 519 attached to a moveable washing chamber 507 is used to force water to flow vertically through the biocarbon product located within chamber 507.

According to various embodiments, chamber 507 is a porous basket having solid metal sides, a wire mesh bottom, and a plenum lid. Wheels may be attached to the basket structure to aid in its motion along track 517, which extends above and along the length of sluice 515. In some embodiments, the basket and plenum lid may be moved together from a supertorrefaction chamber to a wheeled platform that rolls along track 517. The wheeled platform may have an open bottom that allows fluid to flow freely out of the basket and into the sluice 515. In other embodiments, the wheels may be attached to the chamber before or after the supertorrefaction process. In yet other embodiments, the track may include wheels or rollers that allow the chamber to roll when placed on the track. For instance, when the chamber is placed on the track 517 it can interlock or otherwise engage with the track so that it can move in a guided manner along the length of the sluice 515. In other examples, there may be walls on the sides of the rollers that guide the chamber when it glides across the rollers. In these and other embodiments, the rollers or wheels may not need to be attached or fixed to chamber 507.

In the present example, freshwater, treated water, or condensation from other processes associated with supertorrefaction is supplied to the sluice washer 510 from a water source 513. The water from water source 513 is continuously pumped by pump 503 from one end of the sluice 515 to the other end of the sluice 515 towards drain 505. According to various embodiments, the sluice 515 can be a long, rectangular trough made of corrosion-resistant materials such as stainless steel. In some embodiments, the trough 515 is inclined at a gentle slope from a lower end near the drain 505 to a higher end near the pump 503 to facilitate the flow of water and salt along the trough 515 and out through the drain 505. Depending on the desired implementation, the sluice 515 can also be shaped in different ways that may improve efficiency of water and salt flow along the length of the sluice. For instance, the sluice 515 may be shaped as a rectangular channel with a flat bottom in some applications, and may be shaped as a u-shaped channel with a curved bottom in other applications. Accordingly, the sluice 515 can be designed with the materials, dimensions (i.e., length, width, and depth) and shape (i.e., cross-sectional shape) to achieve the desired flow dynamics within the channel.

According to various embodiments, a basket 507 containing salt-laden biocarbon product is positioned above sluice 515 near the drain end 505 of the sluice washer 501. The basket 507 gradually moves along track 517 towards the pump end 503 of the sluice washer 501. The salt-laden biocarbon product receives a continuous injection of water from one or more nozzles or spray bars, which may be associated with one or more pumps 519. For instance, water from sluice 515 can be pumped into a basket within chamber 507 using a portable pump 519. In particular embodiments, the water is pumped into a plenum lid of chamber 507. The plenum lid uniformly distributes the water through a basket of biocarbon product located within chamber 507.

As water is pumped onto the salty biocarbon product within chamber 507, it begins to dissolve the salts and carry away the salts present on the biocarbon product's surface and pores. The water becomes salty and flows out through the bottom of the basket in chamber 507 into sluice 515. During this washing process, the local salinity of the water in the sluice 515 below chamber 507 increases as salt is washed from the biocarbon product and into the sluice 515. Specifically, below each location where chamber 507 stops and goes through a wash cycle, the salinity of the water in sluice 515 increases. Because water in sluice 515 flows continuously from the pump 503 end (upstream) to the drain 505 end (downstream), the water upstream from chamber 507 in the sluice 515 remains clean and water downstream from chamber 507 becomes salty. As shown in FIG. 5, clean water pumped through chamber 507 with portable pump 519 is drawn up from sluice 515 on the upstream side of chamber 507.

One advantage to moving the chamber along track 517 for successive washing cycles is that water drawn up from the sluice 515 for washing is less likely to be contaminated by salty water deposited into the sluice 515 by chamber 507 during previous washing cycles because the salty water is less likely to become increasingly concentrated near the chamber 507 at a given location in the sluice. If the chamber remains stationary in one location during successive wash cycles, salty water may accumulate at one location in sluice 515 and may take some time before the salinity at this location dissipates as the water flows out towards drain 505. Depending on the flow rates of the water in sluice 515, salt may also accumulate on the bottom of the sluice and may slowly wash away with continuous flow of water through the sluice 515. In the present embodiment, each washing cycle deposits more salt into sluice 515 and locations further downstream may have increasing concentrations of salt as it flows towards drain 505. Consequently, by moving the chamber 507 upstream along track 517, it is possible to continue pumping clean washing water into chamber 507 from sluice 515 throughout the washing process.

According to various embodiments, washing chamber 507, which includes a basket to hold biocarbon product, can be mounted on a conveyor system or carriage with wheels, allowing it to be moved along the length of the sluice washer 501. In particular embodiments, the washing chamber 507 begins at a position above the drain end of sluice 515 and moves along track 517 with the assistance of a drive mechanism, which includes drive bar 509 and ratcheted gear drive 511. In the present example, the drive bar 509 is attached to the structure of the washing chamber 507 structure to promote its motion along rails 517 in an upstream direction. In some embodiments, the chamber 507 moves along track 517 intermittently in a sequential step-wise procedure that includes washing the biocarbon product while stopped at a first location on the track, then moving to second location that is upstream from the first location, and washing the biocarbon product while stopped at this second location. This procedure continues with the washing chamber 507 moving upstream along the length of the trough shaped structure 515 toward the pump end of the sluice 505. However, in other embodiments, the chamber 507 can continuously move along track 517 during a continuous or intermittent washing process.

At one end of the sluice washer 501, there is a drain system 505 to collect the salt solution deposited during the washing process and divert it to a separate recovery tank or treatment facility for further processing, reuse, or disposal. In some embodiments, the salt can eventually be reused upon its return to a molten salt reservoir, examples of which were previously described with regard to FIGS. 1 and 2. By reusing the salt in the molten salt reservoir, the supertorrefaction system can operate more efficiently with less waste products.

In particular embodiments, an automation and control system allows operators to adjust and monitor various parameters, including water flow, conveyor speed, and the duration of the washing process. Additionally, the control system may allow operators to program the amount of washing desired. The system may be equipped with sensors that measure salinity at selected locations in the sluice 515 or at other locations in the sluice washer 501, such as in chamber 507 or at the mesh drain of chamber 507. Sensors can also be used to monitor other parameters within the sluice washer 501 depending on the desired implementation. In some embodiments, the sensors can be controlled by a computer program that is used to automate the wash process. The washing parameters implemented by the automation and control system may be adjusted to accommodate the type of incoming biocarbon product, the intended use of the biocarbon product, the type of salt and temperature used in the supertorrefaction process, and other parameters affecting how the biocarbon product was produced during the supertorrefaction process. The control system can be adjusted to the degree of washing desired as some end product uses can tolerate more residual salts than other end product uses.

According to various embodiments, safety measures are integrated into the design to ensure the safe operation of the equipment, including emergency stop mechanisms and guarding to protect personnel. In some embodiments, these safety measures can be implemented by the automation and control system. Additionally, these safety measures can include mechanical or physical features that can protect personnel independently of the operation of the automation and control system.

The present example of a sluice washer 501 demonstrates a system that can be used to implement a continuous and efficient process for washing salt off of biocarbon product produced by a supertorrefaction process. In particular, by pumping water into one end of the sluice, moving the biocarbon product basket along the length of the sluice, and collecting the saline solution at the other end, the sluice washer 501 can effectively clean hot salty biocarbon product while also allowing reuse of water and salt in the supertorrefaction and washing processes. As described, the washing water can come from various sources, such as condensed water produced as a result of the supertorrefaction and/or VOC treatment processes. Furthermore, salt collected in the sluice 515 during the washing process can be recycled and reused as molten salt in the supertorrefaction process.

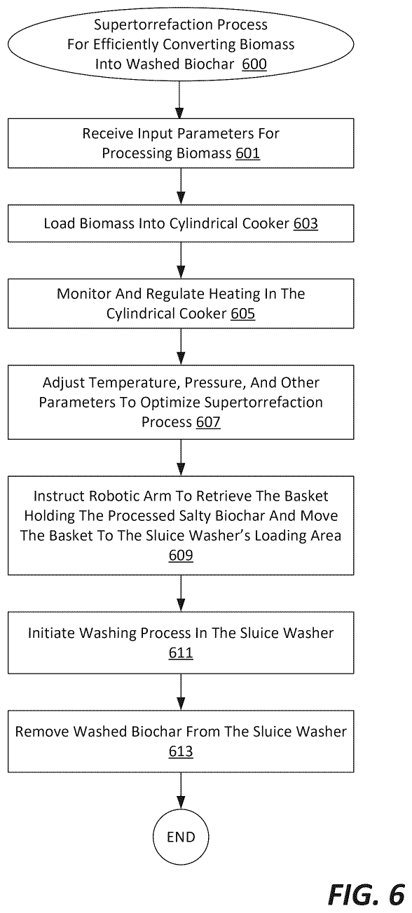

With reference to FIG. 6, shown is a flow process diagram describing one example of a supertorrefaction process for efficiently converting biomass into biocarbon product. According to various embodiments, a system such as the one described above with regard to FIG. 1 is connected to a control unit that can be used to regulate and/or automate the supertorrefaction process. In the present example, a control unit, which is connected to various items within the system, receives input parameters such as the type of biomass, processing time, and temperature settings at 601.

According to various embodiments, a robotic arm, guided by the control unit, loads a cylindrical supertorrefaction basket with biomass to be processed at 603. The control unit monitors and regulates the molten salt heating process inside the supertorrefaction chamber, ensuring it adheres to the desired temperature and time parameters at 605. Throughout the supertorrefaction process, the control unit continuously collects data from the sensors in components such as the basket, the chamber, the pump, the reservoir of molten salt, and the robotic arm.

In particular embodiments, the control system adjusts the temperature, pressure, and other parameters as needed to optimize the supertorrefaction process for efficient biocarbon product production at 607. Once the supertorrefaction process is complete, the control unit instructs the robotic arm to retrieve the processed biocarbon product in the supertorrefaction basket. The robotic arm uses an attachment mechanism to securely grip and lift the basket.

The robotic arm, under the control of the central unit, moves the supertorrefaction basket to the sluice washer's loading area at 609. In some implementations, the supertorrefaction basket is instead tipped so that the biocarbon product is poured out or otherwise transferred into a chamber in the sluice washer. In particular embodiments, the control unit initiates the washing process in the sluice washer at 611. It controls water flow and the movement of the biocarbon product basket along a track from the drain end of the sluice to the pump end of the sluice. In some implementations, the control unit may also control aspects such as agitation of the sluice and the biocarbon product basket. According to various embodiments, sensors in the sluice washer and the robotic arm may provide real-time data about the washing process. The control unit ensures that the biocarbon product is thoroughly washed and substantially free of contaminants if the end use so requires. According to various embodiments, the degree of washing can be set to a level suitable for producing a particular biocarbon product. Biocarbon products for sequestration may require less washing while biocarbon products used for agriculture may require more washing. The amount of washing can be automated using sensors and feedback associated with the control system.

In particular embodiments, multiple lines may be included to allow for simultaneous processing at particular components. For example, multiple cookers and multiple VOCs may be included in a system having a single sluice washer. Alternatively, multiple sluice washers may be included in a system having a single cooker in order to increase throughput and efficiency.

According to various embodiments, the control system includes safety features such as emergency stop buttons and safety interlocks to ensure safe operations. It also logs data from all components, enabling operators to monitor the entire process and troubleshoot any issues. The system logs detailed data for each step of the process, which can be used for quality control, compliance reporting, and process optimization.

In the present example, once the basket holding the biocarbon product reaches the end of the sluice near the pump end, the washed biocarbon product can then be removed from the sluice washer at 613. At this point, the process ends and the washed biocarbon product is the desired end product. According to various embodiments, the washed biocarbon product can then be sequestered or used as fuel in a manner that is carbon neutral or carbon negative. As described in this example, the entire supertorrefaction process can be automated from the time the raw biomass enters the system to the time the washed biomass exits the system.

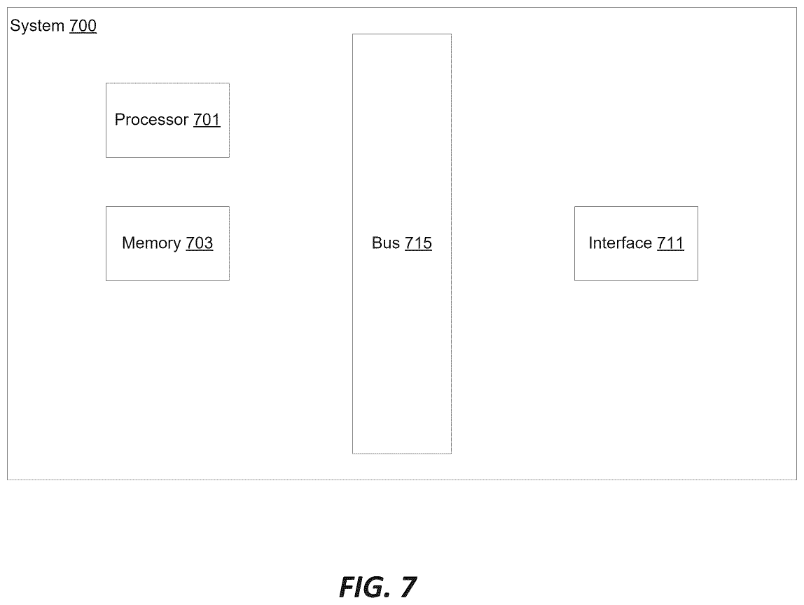

With reference to FIG. 7, shown is a diagrammatic representation of a computer control system. According to various embodiments, the control system 700 can be used to automate the supertorrefaction process described previously with regard to FIG. 6. In particular, a supertorrefaction system, such as the system described with regard to FIG. 1, can be managed and automated by a centralized computer-based control unit. This unit is responsible for coordinating all components of the automation process. For instance, it can control loading of raw biomass into the system, heating and distributing molten salt onto the biomass to convert the biomass to biocarbon product, moving the processed biocarbon product into a sluice washer, operating and controlling the sluice washer, and removing the washed biocarbon product from the washer. The control system 700 can be used to automate various parts of the process and monitor conditions of the system during processing.

According to various embodiments, control system 700 is a particular example of a computer system that can be used to implement particular examples of the present invention. For instance, the control system 700 can be used to implement a computing device, which can include a mobile device, computer, laptop, etc., to automate a supertorrefaction process according to various embodiments described above. In particular example embodiments, a system 700 suitable for implementing particular embodiments of the present invention includes a processor 701, a memory 703, an interface 711, and a bus 715 (e.g., a PCI bus). The interface 711 may include separate input and output interfaces, or may be a unified interface supporting both operations. When acting under the control of appropriate software or firmware, the processor 701 is responsible for such tasks such as optimization. Various specially configured devices can also be used in place of a processor 701 or in addition to processor 701. The complete implementation can also be done in custom hardware. The interface 711 is typically configured to send and receive data packets or data segments over a network. Particular examples of interfaces the device supports include Ethernet interfaces, frame relay interfaces, cable interfaces, DSL interfaces, token ring interfaces, and the like.

In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management.

According to particular example embodiments, the system 700 uses memory 703 to store data and program instructions and maintain a local side cache. The program instructions may control the operation of an operating system and/or one or more applications, for example. The memory or memories may also be configured to store received metadata and batch requested metadata.

Because such information and program instructions may be employed to implement the systems and/or methods described herein, the present invention relates to tangible, machine readable media that include program instructions, state information, etc. for performing various operations described herein. Examples of machine-readable media include hard disks, floppy disks, magnetic tape, optical media such as CD-ROM disks and DVDs; magneto-optical media such as optical disks, and hardware devices that are specially configured to store and perform program instructions, such as read-only memory devices (ROM) and programmable read-only memory devices (PROMs). Examples of program instructions include both machine code, such as produced by a compiler, and files containing higher level code that may be executed by the computer using an interpreter.

As described in various examples of the present disclosure, a supertorrefaction process can be used to convert raw biomass into biocarbon product. Because the raw biomass would otherwise decay and release harmful amounts of CO₂ into the environment, converting this raw biomass to biocarbon product can reduce net carbon emissions to the environment. The processes described in the present disclosure provide several benefits over traditional torrefaction, making it an attractive option for biomass conversion.

According to various embodiments, supertorrefaction can produce a range of biocarbon products, including biocoals, biochar, inert carbon and activated carbon. The range of products may include others that result from interactions of the salts with the biomass and operating conditions. In some example, the biocoal has a higher energy density compared to conventional torrefaction products. Depending on the operating parameters, biochar produced through supertorrefaction has increased reactivity, making it more suitable for various applications, including soil amendment and carbon sequestration. Furthermore, it can effectively capture and retain nutrients and water, enhancing its value in agriculture. Depending on the operating parameters the biocarbon product can also have very high level of inert carbon, suitable for carbon sequestration for up to 1000 years.

Additionally, supertorrefaction tends to produce biochar with lower tar and volatile organic compound (VOC) content compared to torrefaction. This is achieved by effectively removing these compounds during the process, resulting in cleaner biochar and reduced emissions. Reduced tars also prolong the equipment lifespan and save on labor to clean the equipment. Supertorrefaction can process a wider range of biomass feedstocks, including those with high moisture content, more effectively than traditional torrefaction. This broader feedstock flexibility can reduce waste and increase biomass utilization. In many respects supertorrefaction biocarbon products resemble those from fast pyrolysis more than those from conventional torrefaction.

While the present disclosure has been particularly shown and described with reference to specific embodiments thereof, it will be understood by those skilled in the art that changes in the form and details of the disclosed embodiments may be made without departing from the spirit or scope of the invention. Specifically, there are many alternative ways of implementing the processes, systems, and apparatuses described. It is therefore intended that the invention be interpreted to include all variations and equivalents that fall within the spirit and scope of the present invention. Moreover, although particular features have been described as part of each example, any combination of these features or additions of other features are intended to be included within the scope of this disclosure. Accordingly, the embodiments described herein are to be considered as illustrative and not restrictive.

Furthermore, in the foregoing specification, various techniques and mechanisms may have been described in singular form for clarity. However, it should be noted that some embodiments include multiple iterations of a technique or multiple instantiations of a mechanism unless otherwise noted. For example, a system uses a basket in a variety of contexts but can use multiple baskets while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., pipes, channels, sensors, control mechanisms, switches, gates, valves, etc.) may reside between the two entities.

Additionally, in the foregoing specification, reference was made in detail to specific embodiments including one or more of the best modes contemplated by the inventors. While various embodiments have been described in the present disclosure, it should be understood that they have been presented by way of example only, and not limitation. Particular embodiments may be implemented without some or all of the specific details described. In other instances, well known process operations have not been described in detail in order not to unnecessarily obscure the mechanisms and techniques disclosed. Accordingly, the breadth and scope of the present application should not be limited by any of the embodiments described, but should be defined in accordance with the claims and their equivalents.

1. A system comprising
a batch process cooker for thermal processing of biomass, the batch process cooker configured to hold the biomass for high-temperature conversion into biocarbon products;
a biomass basket disposed within the batch process cooker, wherein the biomass basket is configured to hold the biomass during thermal processing;
a plenum lid integrated into the batch process cooker, the plenum lid including a plurality of distribution channels for evenly distributing molten salts onto the biomass within the biomass basket;
a molten salt reservoir positioned below the batch process cooker, the molten salt reservoir storing molten salts utilized for heating and converting the biomass within the biomass basket; and
a molten salt pump configured to pump molten salts from the molten salt reservoir to the plenum lid.

2. The system of claim 1, wherein thermal processing of biomass comprises supertorrefaction at tunable temperatures and time periods with variety molten salt mixtures to produce a range of biocarbon products.

3. The system of claim 1, wherein the biomass basket includes a robotic arm attachment for loading and unloading the biomass basket to and from the batch process cooker.

4. The system of claim 1, wherein the molten salts correspond to a molten salt mixture comprised of any eutectic mixture of individual salts.

5. The system of claim 1, wherein the batch process cooker further comprises a temperature control mechanism for regulating the temperature within the cooker during thermal processing.

6. The system of claim 1, wherein the plenum lid includes an adjustable flow control mechanism for fine-tuning the distribution of molten salts onto the biomass.

7. The system of claim 1, wherein the molten salt reservoir features safety interlocks and emergency shutdown mechanisms for ensuring safe operation.

8. The system of claim 1, further comprising a bypass system between the molten salt reservoir and the plenum lid, the bypass system enabling the recirculation of pumped molten salts to the molten salt reservoir when the biomass is being loaded into or biocarbon product is being removed from the batch process cooker.

9. The system of claim 1, wherein the plenum lid includes heat insulation to protect against heat loss and maintain efficient thermal processing.

10. The system of claim 1, further comprising a sluice washer configured to remove salts from the processed biocarbon product.

11. The system of claim 1, wherein the batch process cooker is a cylindrical cooker, and the biomass basket is a cylindrical basket.

12. The system of claim 11, wherein the cylindrical basket is a cylindrical vessel with solid vertical walls and a mesh bottom that allows the biomass to remain in the cylindrical basket while molten salts pass through the mesh bottom.

13. A sluice washer apparatus for washing biocarbon product or similar materials, comprising:
a trough-shaped structure configured to receive salts and other impurities resulting from washing the biocarbon product;
a water inlet system configured to supply water to the trough-shaped structure from a first end of the trough-shaped structure;
a drain system at a second end of the trough-shaped structure for collecting water, salts, and other impurities;
a biocarbon product basket disposed above the trough-shaped structure, wherein water is also injected onto the biocarbon product basket;
a drive mechanism for moving the biocarbon product basket along the length of the trough-shaped structure; and
a control system for regulating water flow and movement of the biocarbon product basket.

14. The sluice washer of claim 13, wherein the biocarbon product basket is moved from the second end of the trough-shaped structure to the first end of the trough-shaped structure during washing of the biocarbon product.

15. The sluice washer of claim 13, wherein the trough-shaped structure is inclined to facilitate the controlled flow of water, biocarbon product, and saline solution from the first end to the second end.

16. The system of claim 13, wherein the molten salts correspond to a molten salt mixture comprised of any eutectic mixture of individual salts.

17. The sluice washer of claim 13, wherein the water inlet system includes flow control mechanisms for adjusting the water flow rate into the trough-shaped structure and into the biocarbon product basket.

18. The sluice washer of claim 13, wherein the sluice washer is integrated into a system having multiple lines, the multiple lines including multiple sluice washers and multiple condenser systems associated with a single batch process cooker.

19. The sluice washer of claim 13, wherein the sluice washer includes drive mechanism for moving the biocarbon product basket comprises a conveyor system and a drive bar, allowing for smooth and controlled movement of the biocarbon product basket.

20. The sluice washer of claim 13, wherein the biocarbon product basket is a cylindrical vessel with solid vertical walls and a mesh bottom that allows the biocarbon product to remain in the biocarbon product basket while the salts pass through the mesh bottom.
